(19) United States
(12) Patent Application Publication
(10) Pub. No.: US 2002/0166742 A1
(43) Pub. Date: Nov. 14, 2002

(54) Drum brake

(75) Inventor: Toshifumi Maehara, Tokyo (JP)

Correspondence Address: MORGAN LEWIS & BOCKIUS LLP, 1111 PENNSYLVANIA AVENUE NW, WASHINGTON, DC, 20004, US

(73) Assignee: AKEBONO BRAKE INDUSTRY CO.,LTD.

(21) Appl. No.: 10/132,276

(22) Filed: Apr. 26, 2002

(30) Foreign Application Priority Data
May 9, 2001 (JP) P2001-138852

(51) Int. Cl. F16D 51/00

(52) U.S. Cl. 188/325; 188/329

(57) ABSTRACT

A shoe driving mechanism includes cam plates which respond to a shoe operating force to rotate about a main anchor pin on a back plate by a shoe operating force, and three pins consisting of an input pin, a secondary anchor pin and a primary anchor pin, which are uprightly disposed in a space between the cam plates. A secondary anchor pin and a primary anchor pin, respectively, expand a secondary shoe and a primary shoe by the rotating motions of the cam plates, caused by a shoe operating force. At forward braking and backward braking, those anchor pins cause rotation moments to act on the cam plates in such a direction as to lessen the shoe operating force in accordance with a braking force generated by each brake shoe.

### BACKGROUND OF THE INVENTION

1. Field of the Invention

The present invention relates to a drum brake with a shoe driving mechanism incorporated thereinto which controls a pressing force of the brake shoe against the drum in accordance with a braking force at both forward braking and backward braking of the vehicle, thereby ensuring high braking performance and stability.

2. Description of the Related Art

Various types of drum brakes have been used for braking a running vehicle. Those drum brakes are categorized into a leading trailing type drum brake, a two leading shoe type drum brake, a duo-servo type drum brake, and the like, depending on the arrangement of the brake shoe pressed against the inner peripheral surface of a cylindrical drum.

Of these types of drum brakes, the duo-servo type drum brake includes a pair of brake shoes, a primary shoe and a secondary shoe, which are oppositely disposed within a cylindrical drum.

The primary shoe is arranged such that its inlet side in a forwardly rotating direction of the drum serves as an input portion, and its outlet side in the forwardly rotating direction of the drum is linked to an inlet side of the secondary shoe through, for example, an adjuster. Meanwhile, an outlet side of the secondary shoe abuts against an anchor portion mounted on a back plate, and a braking force (braking torque) acting on the primary shoe and the secondary shoe is received by the anchor portion.

With this mechanical arrangement, if the primary shoe and the secondary shoe are extended and pressed against the inner peripheral surface of the drum, a braking force acting on the primary shoe inputs to the inlet side of the secondary shoe, and presses the secondary shoe against the inner peripheral surface of the drum. Accordingly, the primary shoe and the secondary shoe operate both as leading shoes, thereby producing a braking force with an extremely high gain.

The duo-servo type drum brake produces an extremely high braking effect when compared with the leading trailing type drum brake and the two leading shoe type drum brake. Further, the duo-servo type drum brake has other advantages in that the size reduction of this type of drum brake is easy and that the assembling of the parking brake into the brake structure is easy.

However, the duo-servo type drum brake is disadvantageous in that it is sensitive to variations of the frictional coefficients of the lining of the brake shoes. Accordingly, it is hard to stabilize the braking force, and some efforts to stabilize the braking force is required.

In view of the foregoing background, the applicant of this invention has already proposed a shoe driving mechanism in which a hydraulic-pressure controlling valve is incorporated in a wheel cylinder of a hydraulic pressure type for extending the pair of brake shoes, and the supply of hydraulic pressure to the wheel cylinder is controlled in correspondence with the braking force, thereby stabilizing the braking force.

However, with the braking devices for vehicles in recent years, attempts to make brake functions intelligent are being actively undertaken, such as the provision of an anti-lock brake system and the provision of a traction control system. In addition, development of electric vehicles (EV) and hybrid vehicles is also being actively undertaken in view of the alleviation of environmental pollution and the like. To cope with these tendencies toward intelligent brake functions, electric vehicles, and the like, it has been an important issue to adopt an electrically powered system for the brake apparatus.

In adopting the electrically powered system for the brake device, instead of the conventional wheel cylinder of the hydraulic pressure type, an operating-force generating mechanism of an electrically powered type making use of an electric motor or the like is adopted, for example. In that case, it becomes impossible to make use of the aforementioned shoe driving mechanism for controlling the supply of hydraulic pressure to the wheel cylinder of the hydraulic pressure type to a value corresponding to the braking force by means of a hydraulic-pressure controlling valve, and the development of a shoe driving mechanism adapted to the operating-force generating mechanism of the electrically powered type is newly required, which has been a new task in the adoption of the electrically powered system for the duo-servo type drum brake.

For this reason, as a shoe driving mechanism adapted to the operating-force generating mechanism of the electrically powered type, a link mechanism has been proposed for transmitting the output of the operating-force generating mechanism to the pair of brake shoes. However, the conventional link mechanisms for shoe driving have numerous component parts, and there has been a problem in that the operating efficiency in assembly is poor.

Moreover, the conventional shoe-driving link mechanism, generally, stabilizes the braking force at forward braking or backward braking. To stabilize the braking force at both forward braking and backward braking, problems of further increase of component parts and mechanism complexity arise.

### SUMMARY OF THE INVENTION

With the view of above circumstances, the present invention has an object to provide a drum brake with a shoe driving mechanism incorporated thereinto which controls a pressing force of the brake shoe against the drum in accordance with a braking force at both forward braking and backward braking of the vehicle, thereby ensuring high braking performance and stability. Further, an operating-force generating mechanism to be combined with the drum brake may be any of an electrically powered type actuator or a hydraulic-pressure type actuator or a manual-type link mechanism. Moreover, the shoe driving mechanism may have a good versatility, and requires a relatively small number of component parts, and, in this respect, succeeds in facilitating the assembling work.

To achieve the above objects, there is provided a drum brake with a shoe driving mechanism which presses a pair of brake shoes disposed within a drum against the drum in response to a shoe operating force, and controls a torque by a braking force acting on an anchor portion,

wherein the shoe driving mechanism includes cam plates rotatable about a main anchor pin standing erect on a back plate, and the cam plates receive the shoe operating force to rotate and abut against one ends of the brake shoes to expand the brake shoes, and receive a pressing force corresponding to braking forces generated by the brake shoes at braking, and rotate in a direction opposite to that in which the cam plates rotate when receiving the shoe operating force, to thereby decrease the shoe operating force.

Further, according to the drum brake according to the invention, the cam plates are installed with an input pin for receiving the shoe operating force, a secondary anchor pin which comes in contact with one of the pair of brake shoes to expand the one brake shoe to the drum, and at forward braking, applies a pressing force corresponding to a braking force of the one brake shoe at forward braking to the cam plates, and a primary anchor pin which comes in contact with the other brake shoe of the pair of brake shoes to expand the other brake shoe to the drum, and at backward braking, applies a pressing force corresponding to a braking force of the other brake shoe at backward braking to the cam plates.

Further, in the drum brake thus constructed, at forward braking and backward braking, when a shoe operating force W is input from the operating-force generating mechanism to the input pin of the shoe driving mechanism, an input rotational moment M₁ acts on the cam plates in an angular direction about the main anchor pin. Assuming that a distance between the input pin and the main anchor pin is L₁, then the input rotational moment M₁ is mathematically expressed by M₁=W×L₁. Under the input rotational moment M₁, the cam plates start to rotate about the main anchor pin.

By the rotation of the cam plates, the primary anchor pin expands the primary shoe to the inner periphery of the drum, and the secondary anchor pin expands the secondary shoe to the inner periphery of the drum. Those brake shoes are pressed against the inner periphery of the drum, whereby a braking force is generated.

In a state that the braking force is being generated at forward braking, a pressing force Fα corresponding to a braking force generated by the secondary shoe acts on the secondary anchor pin, which is in contact with the end of the secondary shoe. The pressing force Fα causes the main anchor pin apply to the cam plates a rotational moment M₂ for the torque control at forward running of the vehicle, which is opposite in direction of the input rotational moment M₁. Assuming that a distance between the main anchor pin and the secondary anchor pin is S₁, the rotational moment M₂ for the torque control at forward running of the vehicle is M₂=Fα×S₁.

The rotational moment M₂ for the torque control at forward running of the vehicle acts in such a direction as to decrease the input rotational moment M₁, thereby decreasing a pressing force of the primary shoe against the drum, and holding down the braking force within a predetermined level.

In a state that the braking force is being generated at backward braking, a pressing force Fβ corresponding to a braking force generated by the primary shoe acts on the primary anchor pin, which is in contact with the end of the primary shoe. The pressing force Fβ causes the main anchor pin to apply to the cam plates a rotational moment M₃ for the torque control at forward running of the vehicle, which is opposite in direction of the input rotational moment M₁. Assuming that a distance between the main anchor pin and the primary anchor pin is S₂, the rotational moment M₃ for the torque control at backward running of the vehicle is M₃=Fβ×S₂.

The rotational moment M₃ for the torque control at backward running of the vehicle acts in such a direction as to decrease the input rotational moment M₁, thereby decreasing a pressing force of the secondary shoe against the drum, and holding down the braking force within a predetermined level.

### BRIEF DESCRIPTION OF THE DRAWINGS

FIG. 1 is a front view showing an embodiment of a drum brake incorporating thereinto a shoe driving mechanism constructed according to the present invention.

FIG. 2 is an enlarged front view showing a cam plate constituting a shoe driving mechanism of the FIG. 1 drum brake.

FIG. 3 is a side view showing the FIG. 2 cam plate as viewed in a direction of an arrow A.

FIG. 4 is an enlarged view for explaining an operation of the FIG. 1 shoe driving mechanism at forward braking.

FIG. 5 is an enlarged view useful in explaining an operation of the FIG. 1 shoe driving mechanism at backward braking.

### DETAILED DESCRIPTION OF THE PREFERRED EMBODIMENTS

The preferred embodiment of a drum brake according to the present invention will be described with reference to the accompanying drawings.

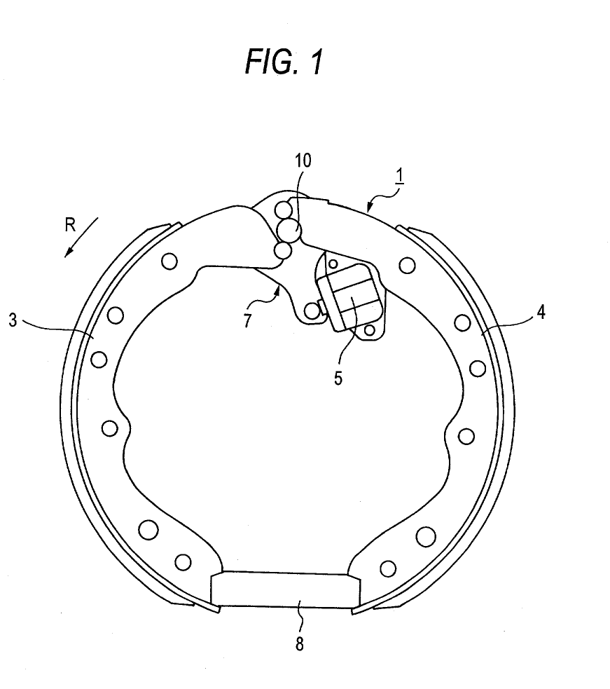

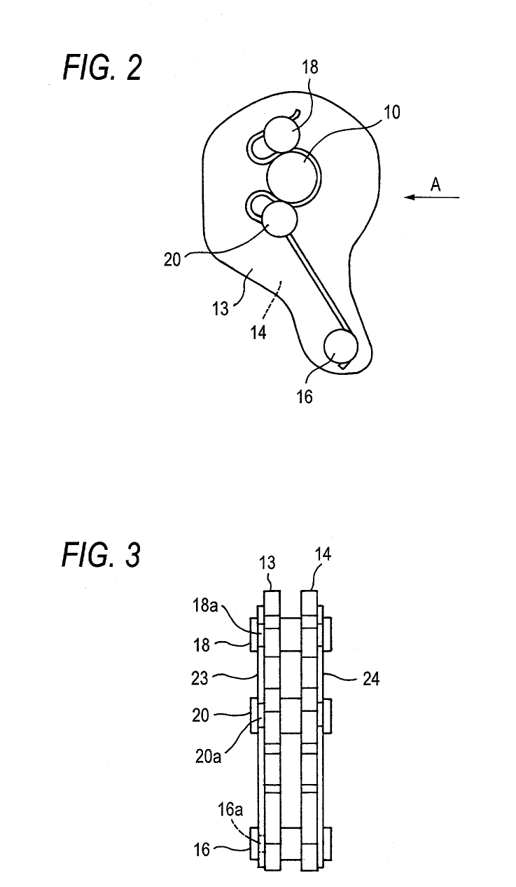

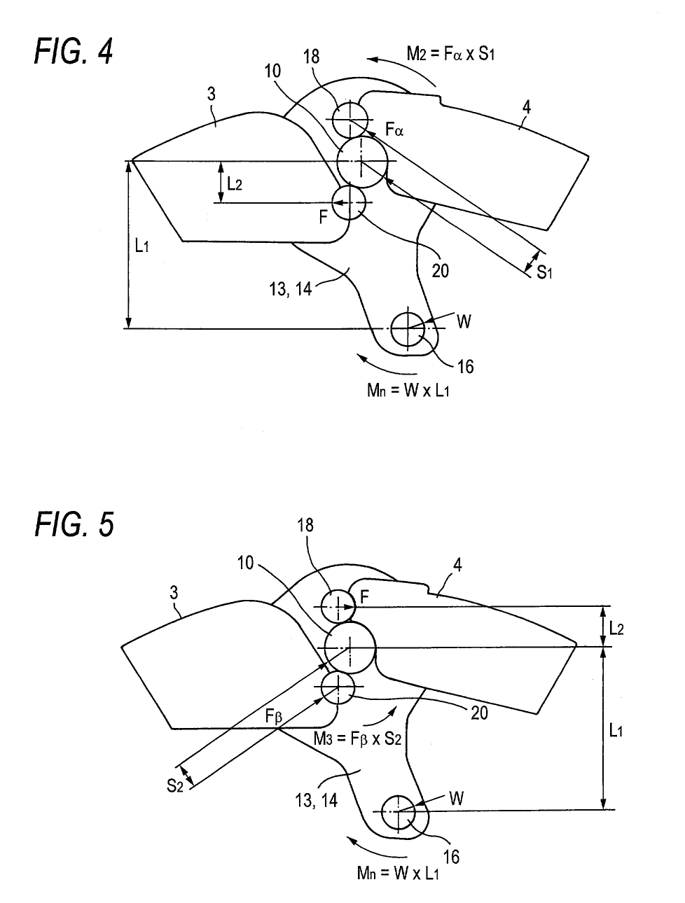

FIGS. 1 through 5 are diagrams showing an embodiment of a drum brake according to the present invention. Of those figures, FIG. 1 is a front view showing a drum brake of the invention. FIG. 2 is an enlarged front view showing cam plates constituting a shoe driving mechanism of the drum brake as shown in FIG. 1; FIG. 3 is a side view showing the FIG. 2 cam plate when viewed in a direction of an arrow A; FIG. 4 is an enlarged view useful in explaining an operation of the FIG. 1 shoe driving mechanism at forward braking. FIG. 5 is an enlarged view useful in explaining an operation of the FIG. 1 shoe driving mechanism at backward braking.

A drum brake 1 of the embodiment is a called duo-servo type drum brake. The drum brake 1 includes a pair of brake shoes 3 and 4, i.e., a primary shoe 3 and a secondary shoe 4, an operating-force generating mechanism 5, a shoe driving mechanism 7, an adjuster unit 8, a back plate (not shown), and a main anchor pin 10. Those brake shoes 4 are oppositely disposed within an inner space of a substantially cylindrical drum (not shown). The operating-force generating mechanism 5 is disposed at the opposed one ends of the paired brake shoes 3 and 4, and generates a shoe operating force W for pressing the brake shoes 3 and 4 against the drum. The shoe driving mechanism 7 expands the brake shoes 3 and 4 in accordance with the shoe operating force W generated by the operating-force generating mechanism 5. The adjuster unit 8 is disposed between the opposed other ends of the brake shoes 3 and 4, and also serves as a link mechanism for inputting an output force of the primary shoe 3 to the secondary shoe 4. The back plate (not shown) supports those members. The main anchor pin 10 is disposed uprightly on the back plate.

The drum (not shown) is disposed coaxial with the back plate, and rotates in a direction of an arrow R in FIG. 1 when the vehicle moves forward.

The brake shoes 3 and 4 are mounted onto the back plate by a shoe hold-down device (not shown) so that it is movable toward the inner periphery of the drum.

The ends of the brake shoes 3 and 4, which are located closer to the operating-force generating mechanism 5, are coupled to the main anchor pin 10 with shoe return springs intervening therebetween, whereby the ends of the respective shoes 3 and 4 are urged in the directions which those approach (i.e., in the directions which those move away from the drum).

The ends of the brake shoes 3 and 4, which are located to the adjuster unit 8, are respectively urged by the urging force of the shoe return springs or the adjuster spring so as to keep a state that those are in contact with the ends of the adjuster unit 8.

The adjuster 8 normally adjusts the space between the ends of the brake shoes 3 and 4 in accordance with the progress of wear of linings of the brake shoes 3 and 4.

The shoe driving mechanism 7 of the embodiment, as shown in FIGS. 1 to 3, includes a pair of cam plates 13 and 14 rotatably supported by the main anchor pin 10 standing erect on the back plate, and three pins, an input pin 16, a secondary anchor pin 18 and a primary anchor pin 20, which are uprightly disposed in a space between the cam plates 13 and 14.

The pair of cam plates 13 and 14 are plates formed in the same shape, and disposed vertically and oppositely.

The input pin 16 stands upright on the cam plates 13 and 14, and serve as an action part of the shoe operating force W. The input pin causes an input rotational moment M₁ based on a shoe operating force W to act on the cam plates 13 and 14 in an angular direction about the main anchor pin 10.

The secondary anchor pin 18 is uprightly disposed on the cam plates 13 and 14, while being in contact with the end of the secondary shoe 4. The secondary anchor pin expands the secondary shoe 4 toward the drum side by the rotating motions of the cam plates 13 and 14, caused by an input rotational moment M₁. When the vehicle moves forward, the anchor pin causes a rotational moment M₂ for the torque control at forward running of the vehicle to act on the cam plates 13 and 14 in such a direction as to lessen the input rotational moment M₁ in accordance with a braking force generated by the secondary shoe 4.

The primary anchor pin 20 is uprightly disposed on the cam plates 13 and 14, while being in contact with the end of the primary shoe 3. The primary anchor pin expands the primary shoe 3 toward the drum side by the rotating motions of the cam plates 13 and 14, caused by the input rotational moment M₁. When the vehicle moves backward, the anchor pin causes a rotational moment M₃ for the torque control at backward running of the vehicle to act on the cam plates 13 and 14 in such a direction as to lessen the input rotational moment M₁ in accordance with a braking force generated by the primary shoe 3.

The fitting grooves 16a, used for their slipping-off prevention, are formed in the input pin 16 at the reduced diameter portions of both ends of the input pin, which pass through the cam plates 13 and 14. The fitting grooves 18a and 20a are likewise formed in those pins 18 and 20. Those pins are firmly fastened to the cam plates 13 and 14 in a manner that both ends of each of those pins are inserted through the cam plates 13 and 14, and then clips 23 and 24 are fit to the fitting grooves 16a, 18a and 20a.

The cam plates 13 and 14 are brought into contact with the steps of the pins 16, 18, 20, whereby those plates are spaced from each other at a fixed distance.

The clips 23 and 24 are each formed by bending a spring steel wire so as to make the round of each fitting grooves 16a, 18a, 20a.

In a state that the pins 16, 18, 20 are fixed to the cam plates 13 and 14 by means of the clips 23 and 24 in a slipping-off preventing manner, the combination of those pins and the cam plates may be handled as a single assembly. Those component parts are assembled into such an assembly, and the assembly thus formed is assembled onto the main anchor pin 10. By so doing, the assembling work is easy.

The secondary anchor pin 18 and the primary anchor pin 20 stand erect in the space between the cam plates 13 and 14 at positions on both sides of the main anchor pin 10. The secondary anchor pin 18 and the primary anchor pin 20 are disposed close to the main anchor pin 10.

In the drum brake 1 of the embodiment thus constructed, at forward braking and backward braking, when a shoe operating force W is input from the operating-force generating mechanism 5 to the input pin 16 of the shoe driving mechanism 7, an input rotational moment M₁ acts on the cam plates 13 and 14 in an angular direction about the main anchor pin 10, as shown in FIGS. 4 and 5. Assuming that a distance between the input pin 16 and the main anchor pin 10 is L₁, then the input rotational moment M₁ is mathematically expressed by M₁=W×L₁. Under the input rotational moment M₁, the cam plates 13 and 14 start to rotate about the main anchor pin 10.

By the rotation of the cam plates 13 and 14, the primary anchor pin 20 expands the primary shoe 3 to the inner periphery of the drum, and the secondary anchor pin 18 expands the secondary shoe 4 to the inner periphery of the drum. Those brake shoes are pressed against the inner periphery of the drum, whereby a braking force is generated.

In a state that the braking force is being generated at forward braking, a pressing force Fα corresponding to a braking force generated by the secondary shoe 4 acts on the secondary anchor pin 18, which is in contact with the end of the secondary shoe 4, as shown in FIG. 4.

The pressing force Fα causes the main anchor pin 10 to apply to the cam plates 13 and 14 a rotational moment M₂ for the torque control at forward running of the vehicle, which is opposite in direction of the input rotational moment M₁. Assuming that a distance between the main anchor pin 10 and the secondary anchor pin 18 is S₁, the rotational moment M₂ for the torque control at forward running of the vehicle is M₂=Fα×S₁.

The rotational moment M₂ for the torque control at forward running of the vehicle acts in such a direction as to decrease the input rotational moment M₁, thereby decreasing a pressing force of the primary shoe 3 against the drum, and holding down the braking force within a predetermined level.

In a state that the braking force is being generated at backward braking, a pressing force Fβ corresponding to a braking force generated by the primary shoe 3 acts on the primary anchor pin 20, which is in contact with the end of the primary shoe 3, as shown in FIG. 5.

The pressing force Fβ causes the main anchor pin 10 to apply to the cam plates 13 and 14 a rotational moment M₃ for the torque control at backward running of the vehicle, which is opposite in direction of the input rotational moment M₁. Assuming that a distance between the main anchor pin 10 and the primary anchor pin 20 is S₂, the rotational moment M₃ for the torque control at backward running of the vehicle is M₃=F×S₂.

The rotational moment M₃ for the torque control at backward running of the vehicle acts in such a direction as to decrease the input rotational moment M₁, thereby decreasing a pressing force of the secondary shoe 4 against the drum, and holding down the braking force within a predetermined level.

The thus constructed drum brake controls a pressing force of the brake shoe against the drum in accordance with a braking force at both forward braking and backward braking of the vehicle, thereby ensuring high braking performance and stability.

The operating-force generating mechanism 5 which applies a shoe operating force onto the input pin 16 may be any of an electrically powered type actuator or a hydraulic-pressure type actuator or a manual-type link mechanism. In this respect, it has a good versatility, and is suitable for designing the drum brake to be electrically powered or driven.

The shoe driving mechanism 7 has a simple construction by merely uprightly disposing three pins, an input pin 16, a secondary anchor pin 18 and a primary anchor pin 20, on the pair of cam plates 13 and 14 rotatably supported by the main anchor pin 10. Accordingly, it requires a decreased number of component parts, and ameliorates the operating efficiency in assembly.

In the embodiment, the shoe driving mechanism 7 is an assembly in which three pins, the input pin 16, the secondary anchor pin 18 and the primary anchor pin 20 are uprightly disposed in a space between the cam plates 13 and 14. However, the shoe driving mechanism may take a single plate structure of the cam plate in which the pins are omitted, if the structure satisfies the required mechanical strength, formability and manufacturing accuracy.

As seen from the foregoing description, the shoe driving mechanism includes the cam plates which responds to a shoe operating force and rotates the brake shoes so as to be pressed against the drum, and receives braking forces from the brake shoes and rotates so as to decrease the operation of the shoe operating force, thereby ensuring high braking performance and stability.

More specifically, at forward braking and backward braking, an input rotational moment M₁ acts to rotate the cam plates about the main anchor pin: M₁=W×L₁, where W=shoe operating force input from the operating-force generating mechanism to the input pin of the shoe driving mechanism, and L₁=distance between the input pin and the main anchor pin. When the cam plates are rotated about the main anchor pin by the input rotational moment M₁, the primary anchor pin expands the primary shoe to the inner periphery of the drum, and the secondary anchor pin expands the secondary shoe to the inner periphery of the drum. Those brake shoes are pressed against the inner periphery of the drum, whereby a braking force is generated.

In a state that the braking force is being generated at forward braking, a pressing force Fα corresponding to a braking force generated by the secondary shoe acts on the secondary anchor pin, which is in contact with the end of the secondary shoe. The pressing force Fα causes the main anchor pin to apply to the cam plates a rotational moment M₂ (=Fα×S₁) for the torque control at forward running of the vehicle, which is opposite in direction of the input rotational moment M₁, where S₁ is a distance between the main anchor pin and the secondary anchor pin.

The rotational moment M₂ for the torque control at forward running of the vehicle acts in such a direction as to decrease the input rotational moment M₁, thereby decreasing a pressing force of the primary shoe against the drum, and holding down the braking force within a predetermined level.

In a state that the braking force is being generated at backward braking, a pressing force Fβ corresponding to a braking force generated by the primary shoe 3 acts on the primary anchor pin 20, which is in contact with the end of the primary shoe 3. The pressing force Fβ causes the main anchor pin to apply to the cam plates a rotational moment M₃ (=Fβ×S₂) for the torque control at backward running of the vehicle, which is opposite in direction of the input rotational moment M₁, where S₂ is a distance between the main anchor pin and the primary anchor pin.

The rotational moment M₃ for the torque control at backward running of the vehicle acts in such a direction as to decrease the input rotational moment M₁, thereby decreasing a pressing force of the secondary shoe against the drum, and holding down the braking force within a predetermined level.

Thus, a shoe driving mechanism of the present invention controls a pressing force of the brake shoe against the drum in accordance with a braking force at both forward braking and backward braking of the vehicle, thereby ensuring high braking performance and stability.

The operating-force generating mechanism which applies a shoe operating force onto the input pin may be any of an electrically powered type actuator or a hydraulic-pressure type actuator or a manual-type link mechanism. In this respect, it has a good versatility, and is suitable for designing the drum brake to be electrically powered or driven.

The shoe driving mechanism has a simple construction by merely uprightly disposing three pins, an input pin, a secondary anchor pin and a primary anchor pin, on the pair of cam plates rotatably supported by the main anchor pin. Accordingly, it requires a decreased number of component parts, and ameliorates the operating efficiency in assembly.

What is claimed is:

1. A drum brake comprising:
a drum;
a pair of brake shoes disposed within said drum; and
a shoe driving mechanism pressing said pair of brake shoes against said drum in response to a shoe operating force, and controlling a torque by a braking force acting on an anchor portion,
wherein said shoe driving mechanism includes a cam plate rotatable about a main anchor pin standing erect on a back plate, said cam plate receiving the shoe operating force to rotate with abutting against one ends of said brake shoes to expand said brake shoes, and receiving a pressing force corresponding to braking forces generated by said brake shoes at braking, and rotating in a direction opposite to that in which said cam plate rotates when receiving the shoe operating force, to thereby decrease the shoe operating force.

2. The drum brake according to claim 1, further comprising:
an input pin receiving the shoe operating force;
a secondary anchor pin coming in contact with one of said pair of brake shoes to expand said one brake shoe to the drum, and applying a pressing force corresponding to a braking force of said one brake shoe to said cam plates at forward braking; and
a primary anchor pin coming in contact with the other brake shoe of said pair of brake shoes to expand said other brake shoe to the drum, and applying a pressing force corresponding to a braking force of said other brake shoe to said cam plates at backward braking.
wherein said cam plate is installed with said input pin, said secondary anchor pin, and said primary anchor pin.

3. The drum brake according to claim 1, wherein said shoe driving mechanism includes a pair of said cam plates formed in the same shape and disposed oppositely.

4. The drum brake according to claim 2, wherein said shoe driving mechanism includes a pair of said cam plates formed in the same shape and disposed oppositely.
